(19) United States
(12) Patent Application Publication
(10) Pub. No.: US 2008/0165444 A1
(43) Pub. Date: Jul. 10, 2008

(54) Baseline popping noise detection circuit

(75) Inventor: Bahjat Zafer, Cupertino, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/803,082

(22) Filed: May 11, 2007

Related U.S. Application Data
(60) Provisional application No. 60/879,184, filed on Jan. 5, 2007.

(51) Int. Cl. G11B 27/36

(52) U.S. Cl. 360/31

(57) ABSTRACT

A technique to detect head instability by monitoring for a baseline popping (BLP) noise effect on demodulation bursts read from a disk. In one technique, a digital filter is employed as a moving average filter so that the filtering of the bursts has a zero output from the filter if only the bursts are present. However, when a BLP event occurs, the noise effect causes a non-zero output from the filter. A threshold value is set and when the output of the filter exceeds the threshold value, a BLP indication is noted. Although various filters may be used, in one technique, a filter suitable for use in detecting thermal asperity defects is used for the BLP detection filter.

### CROSS REFERENCE TO RELATED APPLICATION

This application claims the benefit of priority to U.S. Provisional Patent Application Ser. No. 60/879,184; filed Jan. 5, 2007; and titled “Baseline popping noise detection circuit,” which is incorporated herein by reference.

### BACKGROUND OF THE INVENTION

1. TECHNICAL FIELD OF THE INVENTION

The embodiments of the invention relate generally to disk drives and, more particularly, to providing detection of baseline popping noise.

2. DESCRIPTION OF RELATED ART

Varieties of memory storage devices, such as magnetic disk drives, are available to store data and are used to provide data storage for a host device, either directly, or through a network. Those networks may be a storage area network (SAN) or a network attached storage (NAS). Typical host devices include stand alone computer systems such as a desktop or laptop computer, enterprise storage devices such as servers, storage arrays such as a redundant array of independent disk (RAID) arrays, storage routers, storage switches and storage directors, and other consumer devices such as video game systems and digital video recorders. These devices generally provide high storage capacity in a cost effective manner.

One class of disk storage devices uses magnetic media to store information. In order to ensure that digital data is written to the disk and retrieved correctly, it is desirable to have defect-free media and a controller that is capable of correctly reading back the stored data. For media defects, various defect scanning techniques may be utilized to map defective sectors after the disk is manufactured. For example, media defects that cause dropin and dropout conditions (due to too much or not enough magnetic material on the magnetic media) may be determined during a defect scan. Likewise, transient voltage aberrations may be detected using thermal asperity (TA) defect detection schemes during a defect scan. These media defects are generally detected by performing a self-scan by storing a known test pattern and looking for changes in the pattern during a read back. However, other types of defective conditions are not strictly media related and may not be resolved by reading back a test pattern to map out a defective sector.

Baseline popping (BLP), which causes baseline popping noise (BLPN), is characterized by the spurious popping of baseline between readback pulses from magnetoresistive heads. One of the causes of BLP is due to head instability. Unlike the media defects noted above which are media-related, BLP is a non-stationary defect attributed to head-related phenomenon. Since BLP is not necessarily fixed to a given region (e.g. sector) of the disk, the defect may not be readily mapped to a defect entry table, as with media-related defects. Furthermore, since a BLP event may occur during normal use of the disk at random times and at random locations, detection of a BLP event during use is helpful.

When a BLP event occurs during the time user data is being read from the disk, there is most likely some form of data correction mechanism (such as error correction code (ECC)) that may be implemented to correct for data errors. Thus, a BLP event during user data reads may not be critical for correct data reads. However, there are periods when a BLP event may have a more significant impact. For example, head instability conditions that cause a BLP event may result when servo information is being read from the disk. An erroneous servo read may cause a faulty position error signal (PES) to be generated. A faulty PES may then throw the tracking off, so that erroneous information is read from the disk. Since error correction is generally not used with servo information, it is advantageous to know when such BLP events occur during servo.

Accordingly, there is a need for a technique to diagnose or detect a BLP event during servo reads.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 shows an embodiment of a disk drive device for practicing the invention.

FIG. 2 shows one embodiment of an apparatus that has a disk controller that implements the invention.

FIG. 3 shows one example of a sector signal from a disk in which servo and data information are read from the disk.

FIG. 4 shows one example waveform when a baseline popping (BLP) event occurs.

FIG. 5 shows a portion of a read/write channel of a disk controller that includes one embodiment of a BLP detection module.

FIG. 6 shows one embodiment of a BLP detection module that uses a digital filter and a comparator.

FIG. 7 shows one example technique in using the filter of FIG. 6.

### DETAILED DESCRIPTION OF THE EMBODIMENTS OF THE INVENTION

The embodiments of the present invention may be practiced in a variety of settings that implement a disk drive, such as a hard disk drive (HDD), or other data storage devices. Although the technique described below pertains to disk drives that utilize demodulation bursts, it need not be limited strictly to demodulation bursts or disk drive. Furthermore, the example embodiments described below use a time averaging filter to detect BLP events, but other embodiments may use other techniques to detect BLP.

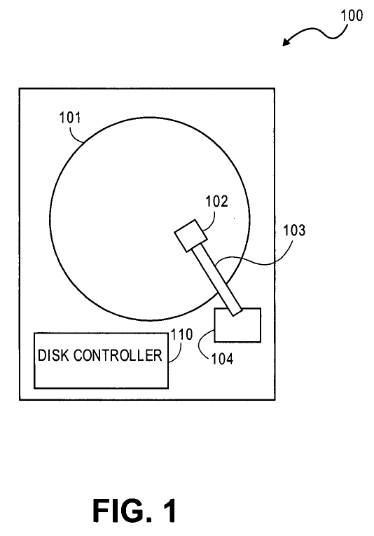

FIG. 1 illustrates an example embodiment of a disk drive 100 for practicing an embodiment of the invention. In particular, disk drive 100 is a HDD device that includes a disk 101 to store data. Disk 101 is typically rotated by a servo motor (not shown) at a specified velocity depending on a particular application for its use. Disk 101 may be constructed from various materials and in one embodiment disk 101 is a magnetic disk that stores information as magnetic field changes on some type of magnetic medium. The medium may be rigid or non-rigid, although HDD devices generally have rigid disks. Disk 101 may be removable or non-removable. Disk 101 typically is made of magnetic material or coated with magnetic material. It is to be noted that in other embodiments, disk 101 may employ other data storage technology, such as an optical medium, and need not be limited to magnetic storage.

Disk drive 100 typically includes one or more read/write heads 102 that are coupled to an arm 103 that is moved by an actuator 104 over the surface of the disk 101 either by translation, rotation or both. Disk drive 100 may have one disk 101, or multiple disks with multiple read/write heads 102. Disk drive 100 includes a disk controller module 110 that is utilized for controlling the operation of the disk drive, including read and write operations to disk 102, as well as controlling the speed of the servo or motor and the motion of actuator 104. Disk controller module 110 may also include an interface to couple to an external device, such as a host device. It is to be noted that disk drive 100 is but one example and other disk drives may be readily implemented to practice various embodiments of the invention.

Disk drive 100, or any other equivalent disk drive, may be implemented in a variety of devices. For example, disk drive 100 may be implemented in a handheld unit, such as a handheld audio unit. In one such embodiment, disk drive 100 may include a small form factor magnetic disk and incorporated into or otherwise used by handheld audio unit to provide general storage, including storage of audio content.

In another example embodiment, disk drive 100 may be implemented in a computer. In one such embodiment, disk drive 100 may include a magnetic disk for various applications, including enterprise storage applications. Disk drive 100 may be incorporated into or otherwise used by a computer to provide general purpose storage and the computer may be attached to a storage array, such as a redundant array of independent disks (RAID) array, storage router, edge router, storage switch and/or storage director. Disk drive 100 may be implemented in a variety of computers (or computing devices), such as desktop computers and notebook computers.

In another example embodiment, disk drive unit 100 may be implemented in a wireless communication device to provide general storage. In one such embodiment, the wireless communication device may communicate via a wireless telephone network such as a cellular, personal communications service (PCS), general packet radio service (GPRS), global system for mobile communications (GSM), integrated digital enhanced network (iDEN) or other wireless communications network capable of sending and receiving telephone calls. Furthermore, the wireless communication device may communicate via the Internet to access email, download content, access websites, and provide streaming audio and/or video programming. In this fashion, the wireless communication device may place and receive telephone calls, text messages, short message service (SMS) messages, pages and other data messages that may include attachments such as documents, audio files, video files, images and other graphics.

Still as another example, disk drive 100 may be implemented in the personal digital assistant (PDA). In one such embodiment, disk drive 100 may include a small form factor magnetic hard disk to provide general data storage. Still in another embodiment, disk drive 100 may be implemented in a television set (such as a high-definition television) or a digital video recorder to store video information.

In these various embodiments for disk drive 100, a variety of data, as well as program instructions, may be stored. Stored data may include, and is not limited to, general data, data for motion picture expert group (MPEG) audio layer 3(MP3) files or Windows Media Architecture (WMA) files, video content such as MPEG4 files, JPEG (Joint Photographic Expert Group) files, bitmap files and files stored in other graphics formats, emails, webpage information and other information downloaded from the Internet, address book information, and/or any other type of information that may be stored on a disk medium.

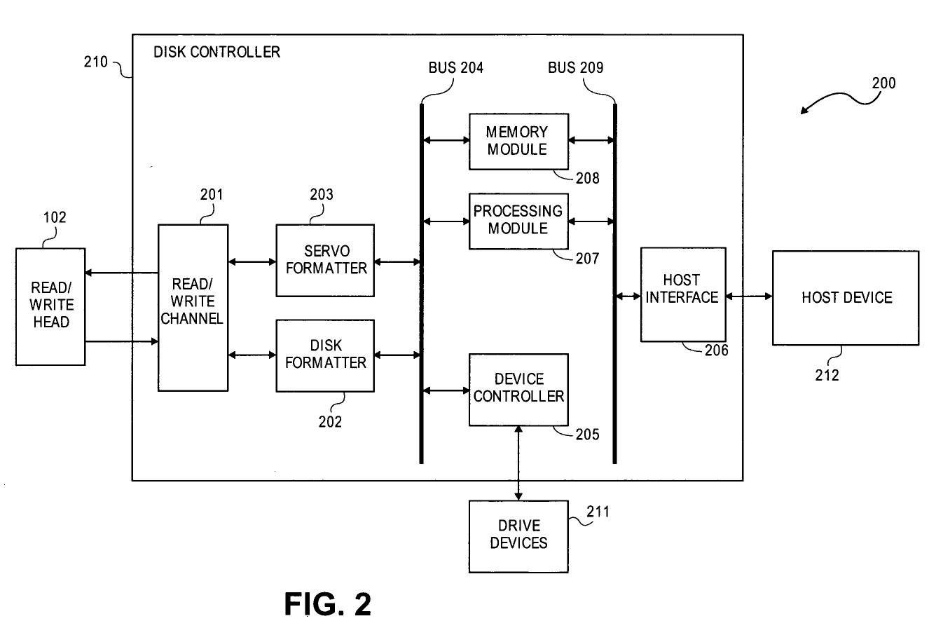

FIG. 2 illustrates an embodiment of an apparatus 200 that may be implemented with disk drive 100 of FIG. 1. Read/write head 102 is shown coupled to a disk controller 210, which may be used for disk controller 110 of FIG. 1. In the particular embodiment, disk controller 210 includes a read/write channel 201 coupled to head 102 for reading and writing data to and from disk 101. A disk formatter 202 is included for controlling the formatting of data and provides clock signals and other timing signals that control the flow of the data written to and data read from disk 101 through read/write channel 201. A servo formatter 203, also coupled to read/write channel 201, provides clock signals and other control and timing signals based on servo control data read from disk 101. Disk formatter 202 and servo formatter 203 are also coupled to bus 204. Disk controller 210 further includes a device controller 205, host interface 206, processing module 207 and memory module 208, as well as a second bus 209. Device controller 205 controls the operation of one or more drive device(s) 211. Device(s) 211 may be one or more device(s) such as actuator 104 and the servo (or spindle) motor used to rotate disk 101. Host interface 206 is coupled between bus 209 and a host device 212 to receive commands from host device 212 and/or transfer data between host device 212 and disk 101 in accordance with a particular protocol.

Processing module 207 may be implemented using one or more microprocessors, micro-controllers, digital signal processors, microcomputers, central processing units, field programmable gate arrays, programmable logic devices, state machines, logic circuits, analog circuits, digital circuits, and/or any device that manipulates signal (analog and/or digital) based on operational instructions. The operational instructions may reside in memory module 208 or may reside elsewhere. When processing module 207 is implemented with two or more devices, each device may perform the same steps, processes or functions in order to provide fault tolerance or redundancy. Alternatively, the function, steps and processes performed by processing module 207 may be split between different devices to provide greater computational speed and/or efficiency.

Memory module 208 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. It is to be noted that when processing module 207 implements one or more of its functions via a state machine, analog circuitry, digital circuitry, and/or logic circuitry, memory module 208 storing the corresponding operational instructions may be embedded within, or reside external to, the circuitry comprising the state machine, analog circuitry, digital circuitry, and/or logic circuitry. Furthermore, memory module 208 stores, and the processing module 207 executes, operational instructions that may correspond to one or more of the steps or a process, method and/or function described herein.

Each of these elements of controller 210 may be implemented in hardware, firmware, software or a combination thereof, in accordance with the broad scope of the present invention. While particular bus architecture is shown in FIG. 2 with buses 204, 209, alternative bus architectures that include either a single bus configuration or additional buses are likewise possible to be implemented as different embodiments.

In one embodiment, one or more modules of disk controller 210 are implemented as part of a system on a chip (SoC) integrated circuit. In the particular embodiment shown, disk controller 210 is part of a SoC integrated circuit that may include other circuits, devices, modules, units, etc., which provide various functions such as protocol conversion, code encoding and decoding, power supply, etc. In other embodiments, the various functions and features of disk controller 210 may be implemented in a plurality of integrated circuits that communicate and combine to perform the functionality of disk controller 210.

When the drive unit 100 is manufactured, disk formatter 203 generally writes a plurality of servo wedges along with a corresponding plurality of servo address marks at radial distance along the disk 101. The servo address marks are used by the timing generator for triggering a “start time” for various events employed when accessing the medium of the disk 101. Generally, these servo address marks are used to separate a particular track of the disk into a number of sectors for formatting the disk. Similarly, a symbol is a term used to identify the smallest element of user data that is transferred between a controller and a channel during a disk transfer. In today's disk drive systems, symbol sizes range from 8-bits to 12-bits, however other sizes may be applicable.

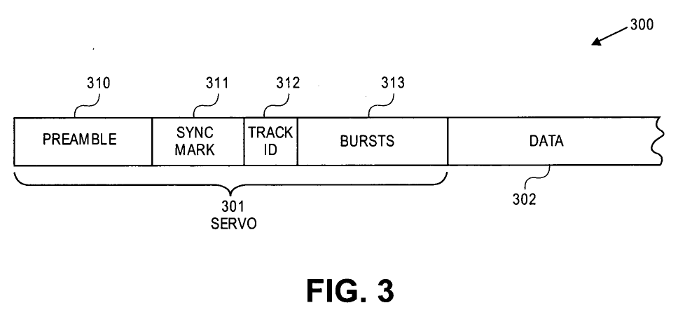

As noted in the Background section above, a BLP event may occur during a period when information is being read from the disk. However, the BLP event may have a more critical impact if it occurs during the time servo information is being read. Accordingly, FIG. 3 shows an example data format for reading information from a disk. In the particular format shown, information 300 is stored on a portion of a disk that is read by a disk head, such as head 102 of FIG. 1. The disk may be partitioned into a plurality of sectors and information 300 may reside on one sector located between servo wedges. Information 300 includes a servo field 301 and user data field 302. Servo field 301 includes a preamble 310, sync mark 311, track ID (identification) 312 and demodulation bursts 313. Servo field 301 may include additional information, but generally the items shown are included within a servo field of many disk drives. The information in the servo field 301 is generally utilized to synchronize the servo to the start of the sector, set gain, identify the track and align the head correctly on the track, as well as other functions that pertain to servo operation. Data field 302 generally includes user data stored on the disk and may also include error correction code as well.

In particular, demodulation bursts (also referred to simply as bursts) 313 are used to provide radial positioning of the head in respect to the particular track. Bursts 313 are generally comprised of a waveform having a number of cycles and typically at a single predetermined frequency. However, in other embodiments, bursts 313 may have other forms and multiple frequencies. The use of bursts to maintain correct tracking of the head is generally known in the art.

If there is an instability condition that causes a BLP event during a read, the BLP noise may impact the information being read from servo field 301. As described below, the BLP event which impacts servo field 301 is detectable by analyzing the effect the BLP noise has on bursts 313. However, other embodiments of the invention may readily operate on other servo fields, as well as on data field 302, and the practice of the invention is not limited to using only the bursts 313.

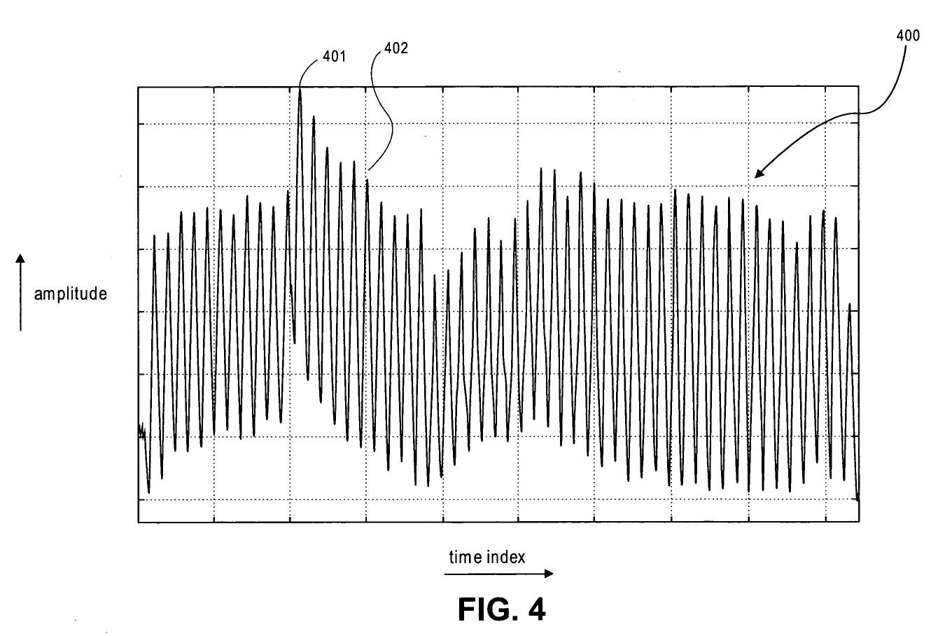

In FIG. 4, a burst waveform 400 is shown that is used for bursts 313 in one embodiment. Most of the standard burst waveforms have substantially constant frequency and different amplitudes. However, the amplitude is generally fixed in any given burst waveform. For example, a typical burst waveform may have four bursts, A, B, C and D. The amplitude of A may be approximately 100%, B may be approximately 50%, C may be approximately 25% and D may be 0%. However, when a BLP event occurs, the resulting BLP noise has a substantially instant rise time as noted at location 401, followed by an exponential decay 402 to the level of the burst signal. In this instance at location 401, the substantially instant rise causes the signal to be all or significantly above zero reference. Alternatively, the BLP event may be in the negative direction.

The BLP model may be represented as:

V_{BLP}(t)={A·e^{-(t/τ}^{_{d}}^{T))}, t≧0},

where A is the BLP amplitude and τ_{d} is the decay-time constant. With regard to waveform 400 of FIG. 4, the sign of amplitude A of the waveform alternates between consecutive BLP events. Values of A may range approximately between 15%-60% of the isolated zero-to-peak signal, while values of τ_{d} may range approximately between 6-20 bits in one embodiment. What is to be noted is that this resulting waveform is very similar to a small thermal asperity (TA) defect condition that is detected with the media. That is, the BLP noise waveform appears very similar to a waveform that is noted with a small TA signal when a TA defect scan is performed. Accordingly, in order to detect an occurrence of a BLP event, burst signals of the servo field may be monitored for a condition similar to detecting a thermal asperity defect, since the BLP noise effect on the burst signal is similar to a TA signal. Thus, various techniques that may be used for detecting TAs may be utilized to detect for BLP.

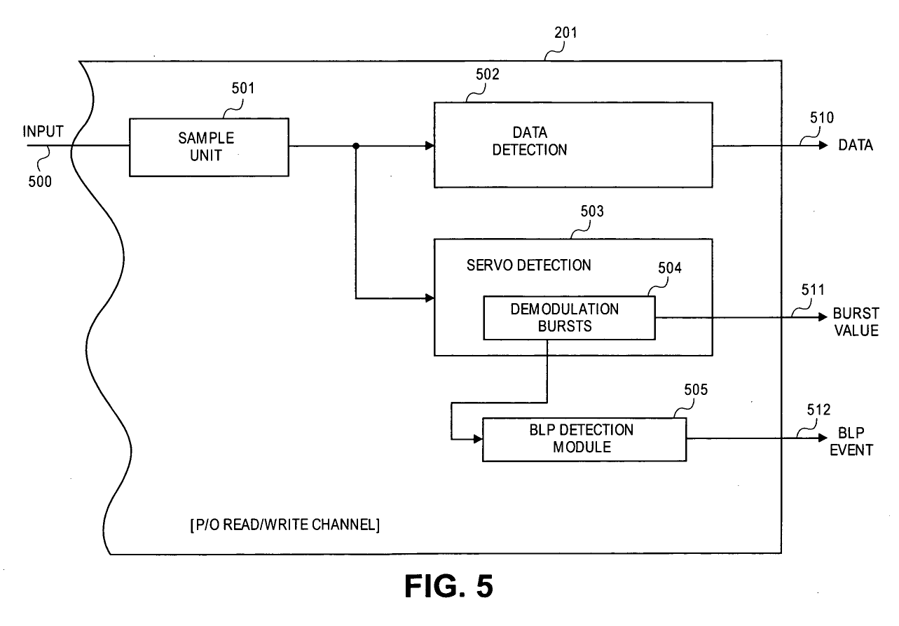

FIG. 5 shows one embodiment of a BLP detection device, which is used to detect a BLP event. BLP detection is performed by BLP detection module 505, which is shown as part of read/write channel 201 in the particular example shown. However, module 505 need not be limited to read/write channel 201. BLP detection module 505 may be placed within servo formatter 203, another component or module, or may even be a separate unit. However, as shown in the example of FIG. 5, BLP detection module 505 resides within read/write channel 201 to receive servo and data input from read/write head 102. Input 500 from read/write head 102 is coupled to a sample unit 501 for sampling the signal. Sample unit 501 may include an analog-to-digital converter (ADC) to convert the input data from analog to digital form.

The sampled servo field information is then processed by servo detection module 503, while sampled user data information is processed by data detection module 502 to generate data output 510. Servo detection module 503 processes the servo information (such as servo field 301) and generates various servo-related signals. Servo detection module 503 also processes the demodulation bursts 504 to generate a burst value 511 for performing the track alignment. It is to be noted that various other signals are generated by servo detection module 503, but only the signals related to demodulation bursts 504 are shown, since only the bursts are of relevance to detecting the BLP event in this embodiment of the invention. Furthermore, in other embodiments the two functions performed by detection modules 502 and 503 may be performed in a single detection module.

As shown in FIG. 5, the bursts are also sent to a BLP detection module 505 to perform the BLP detection. A variety of BLP detection techniques may be provided by BLP detection module 505 to detect a BLP event and generate a BLP signal 512. However since a characteristic of a BLP event on the bursts is similar to having a thermal asperity condition when searching for media defects, in one embodiment an equivalent circuit as that used for detecting TAs is implemented in BLP detection module 505.

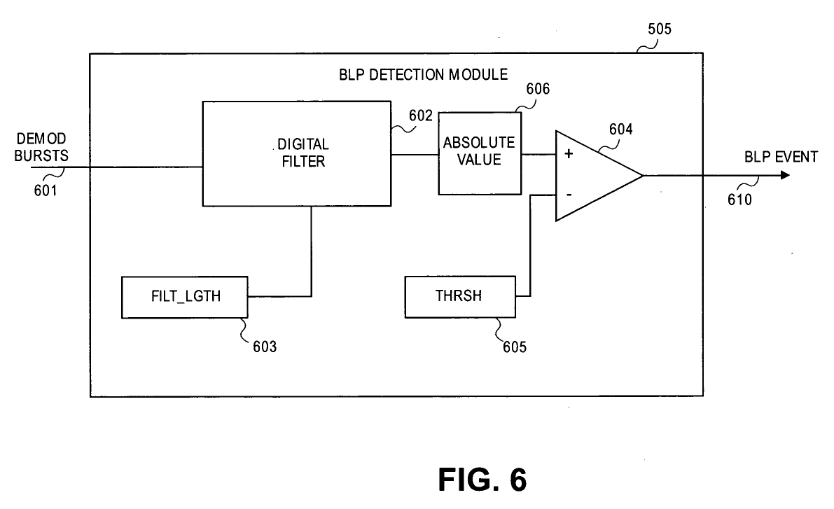

Accordingly, FIG. 6 shows one example embodiment for implementing BLP detection module 505. The bursts 504 from servo detection module 503 are coupled as input 601 to a digital filter 602. The particular digital filter 602 operates to detect a BLP event by a similar technique to detecting a TA when performing a defect scan. More specifically, the TA detection technique uses a moving average, which is commonly implemented by a moving average (MA) filter. A MA filter of length N averages N data samples. In one embodiment, the MA filter is a finite-impulse-response (FIR) filter that has all one coefficients and the signal component for the samples filtered adds to zero.

In order to allow flexibility with the length of the samples being filtered, digital filter 602 allows programmability to select the particular filter length. A filter length value FILT_LGTH is provided to filter 602 to set the length of the filter. In the particular embodiment shown, FILT_LGTH is a programmable value stored in a programmable register 603. The FILT_LGTH value sets the filter length depending on the length of the input 601 and in one embodiment, FILT_LGTH may take on values to support length of 16 and 32. In one embodiment, a one-bit register is used for register 603, in which the “0” or “1” state of the bit selects the respective length of 16 or 32. It is to be noted that other lengths may be readily supported by setting the value of FILT_LGTH.

The output of filter 602 is coupled to an absolute value module 606. Since the output from filter 602 may be positive or negative, an absolute value of the filter output from module 606 is used for the threshold comparison. The absolute value of the output of filter 602 is then coupled to one input of comparator 604. The other input of comparator 604 is coupled to receive a threshold value THRSH. In one embodiment, THRSH is programmable and stored in programmable register 605. The THRSH value is utilized to set a threshold level to trip comparator 604 to indicate that a BLP event has occurred. The particular threshold level to be set by the THRSH value is dependent on the BLP detection level of the signal output from filter 602. In one embodiment, THRSH is an 8-bit value. In other embodiments, THRSH may have different number of bits. Accordingly, when filter 602 detects a BLP event with the bursts, output 610 indicates that a BLP event has occurred, but only when the filter output exceeds the THRSH value.

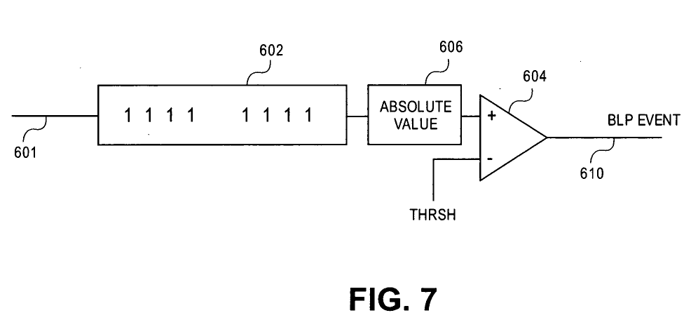

As noted above, various filters and filtering techniques may be used for filter 602. However, as also noted above, a filter designed for TA detection may be made operable to detect a BLP event. Thus, FIG. 7 illustrates one example embodiment for implementing a BLP detector, using filter 602. In the example shown in FIG. 7, filter 602 is equivalent to a filter used to detect TAMA. As noted above and shown in FIG. 7, one embodiment of filter 602 utilizes a FIR filter that has all one coefficients, [1 1 1 1 1 1 1 1]. Since filter 602 supports multiple length (periods such as 4T, 8T and 16T, in one embodiment), signal components filtered by using the TAMA technique are made to add to zero at whatever length being used. Assuming using a particular partial response 1 (PR1) target (such as PR1 target 10*[1+D]) and a period of length eight with bit pattern 11110000 (which is represented as [1 1 1 1−1 −1 −1 −1]), then one output from the filter may be represented as [0 20 20 20 0 −20 −20 −20]. Since performing TAMA to only half the sample (e.g., [0 20 20 20]) would produce a large positive answer that could be mistaken for a BLP event, one technique is to sample all eight samples [0 20 20 20 0 −20 −20 −20]. Thus, for filter 602, samples for the whole period, whether it is 4T (length of 8), 8T (length of 16), 16T (length 32), or some other length, is taken, so that the signal component adds to zero. Furthermore, the noise component is reduced because of the averaging effect, allowing the BLP event to be detected at the output.

With the above filtering technique, the signal component is approximately zero and the noise value at a level below the BLP detection threshold. Therefore, under normal non-BLP condition, the output 610 from detection module 505 is substantially zero. However, when a BLP event occurs and the BLP level is above the THRSH value, detection module 505 signals a BLP event.

A number of advantages may be obtained by utilizing the BLP detection scheme described above. For one, a special pattern need not be written to the disk and read back to detect a BLP event. Normal information stored on the disk may be used to detect for a BLP. Since normally recorded information may be used, the BLP detection may be performed dynamically under normal usage of the disk, instead of at defect scan. Thus, the BLP detection technique described may be used during defect scan or during normal operational use of the disk.

Although various detection circuitries may be employed, the use of TA (or TAMA) filter for BLP detection has an added advantage. Since many disk drives systems include TA (or TAMA) filter(s) to detect defect conditions through detection of thermal asperity, the same filter(s) may be adapted to detect BLP as well. Since digital TA defect detection is typically not performed during sampling of demodulation bursts, the same TAMA filter may be used for TA detection for media defects during periods other than periods of bursts and switched to detect BLP during period of bursts. The programmable filter length allows selection of the length of the filter, so that the filter may have one length during TA defect scan and a different length during BLP detection. Thus, BLP detection may be added with minimal additional circuitry and costs.

Once an indication informs a disk controller that a BLP event has occurred, the controller or other parts of the system may respond accordingly. For example, since an indication of a BLP event may produce erroneous readings, the controller (or the system) may simply ignore the current information being read and request that the information is read again. In any event, a BLP indication during operation of the disk is a good indicator that there is instability in the head operation and information being read may be erroneous. The BLP detection may be used during normal use of the disk drive, during a defect scan, or both.

Thus, a baseline popping noise detection circuit is described. As noted above, the practice of the invention need not be limited to bursts and other embodiments may operate on other components of the servo field, as well as the data field.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant functionality. Such alternate definitions of functional building blocks,. flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

I claim:

1. An apparatus comprising:
a first detection module to detect a signal from a storage medium; and
a second detection module coupled to receive the signal from the first detection module and to filter the signal by use of a thermal asperity filter to detect if a baseline popping (BLP) event has occurred.

2. The apparatus of claim 1, wherein the signal is a component of a servo field received from the storage medium, in which the storage medium is a servo controlled disk drive.

3. The apparatus of claim 1, wherein the thermal asperity filter is a moving average thermal asperity filter.

4. The apparatus of claim 3, wherein the second detection module further includes a comparator to compare a value output from the filter to a threshold value and to indicate that the BLP event has occurred when the value from the filter exceeds the threshold value.

5. The apparatus of claim 4, wherein the moving average thermal asperity filter is of length N to filter the signal, in which an output of the moving average thermal asperity filter is substantially zero without a BLP event, but the filter has a non-zero output when the BLP event is present.

6. The apparatus of claim 5, wherein the moving average thermal asperity filter is programmable to select period length N for the filter.

7. The apparatus of claim 1, wherein the signal is a burst component of a servo field received from the storage medium, in which the storage medium is a servo controlled disk drive.

8. The apparatus of claim 1, wherein the signal is received from a disk drive.

9. An apparatus comprising:
a servo detection module to detect demodulation bursts of a servo signal from a disk; and
a baseline popping (BLP) detection module coupled to receive the demodulation bursts from the servo detection module and to process the demodulation bursts to detect if noise caused by a BLP event is present.

10. The apparatus of claim 9, wherein the servo detection module and the BLP detection module operate dynamically during normal operation of a disk drive to detect BLP noise when information is read from the disk.

11. The apparatus of claim 9, wherein the BLP detection module includes a digital filter to filter the demodulation bursts to obtain a value indicative of BLP noise present.

12. The apparatus of claim 11, wherein the BLP detection module further includes a comparator to compare the value output from the filter to a threshold value and to indicate that BLP noise is present when the value from the filter exceeds the threshold value.

13. The apparatus of claim 9, wherein the BLP detection module includes a moving average digital filter of length N to filter the demodulation bursts, in which an output of the moving average filter is zero when BLP noise is not present, but the filter has a non-zero output when BLP noise is present.

14. The apparatus of claim 13, wherein the moving average filter is programmable to select period length N for the filter.

15. The apparatus of claim 14, wherein the moving average filter is a thermal asperity moving average filter.

16. A method comprising:
detecting demodulation bursts of a servo signal from a disk; and
detecting occurrence of baseline popping (BLP) noise by processing the demodulation bursts to identify a substantially rapid rise of the demodulation bursts followed by exponential decay.

17. The method of claim 16, wherein detecting the occurrence of BLP noise includes filtering the demodulation bursts to obtain a value indicative of BLP noise present.

18. The method of claim 16, wherein detecting the occurrence of BLP noise includes filtering the demodulation bursts using a moving average digital filter of length N, in which an output of the moving average filter is zero when BLP noise is not present, but the filter has a non-zero output when BLP noise is present.

19. The method of claim 18, wherein detecting the occurrence of BLP noise includes comparing an output value from the filter to a threshold value and indicating that BLP noise is present when the value from the filter exceeds the threshold value.

20. The method of claim 17, wherein detecting the occurrence of BLP noise includes filtering the demodulation bursts to obtain a value indicative of BLP noise present by using a filter that detects a thermal asperity defect on the disk.
